(19) United States
(12) Patent Application Publication
(10) Pub. No.: US 2022/0237132 A1
(43) Pub. Date: Jul. 28, 2022

(54) DATA TRANSMISSION METHOD AND PING-PONG DMA ARCHITECTURE

(71) Applicant: INSPUR SUZHOU INTELLIGENT TECHNOLOGY CO., LTD., Suzhou (CN)

(72) Inventors: Hailiang GE, Suzhou (CN); Hongwei KAN, Suzhou (CN)

(21) Appl. No.: 17/595,971

(22) PCT Filed: Sep. 29, 2019
(86) PCT No.: PCT/CN2019/108916

§ 371 Date: Nov. 30, 2021

(30) Foreign Application Priority Data
Jun. 28, 2019 (CN) 201910574765.9

(51) Int. Cl. G06F 13/28; G06F 9/30

(52) U.S. Cl. CPC G06F 13/28; G06F 9/30189; G06F 9/30101

(57) ABSTRACT

The present invention is about a data transmission method and a ping-pong DMA architecture. The method includes: acquiring the current state of an initialized register, determining a state type corresponding to the current state of the register, and performing an operation corresponding to the state type based on the state type determined by the register, the state type includes an initialization state, a state that the first DMA module is used, and a state that the second DMA module is used, the state that the first DMA module is used means a state when a previous batch of data is transmitted by the first DMA module, and the state that the second DMA module is used means a state when the previous batch of data is transmitted by the second DMA module. By using the above-mentioned method, data is configured by using the two DMA modules, when the first DMA module is busy, the second DMA module may also configure the data, and operations of data corresponding to the different states are performed according to the different states of the register, so that the purpose of increasing the data transmission efficiency is achieved.

### CROSS-REFERENCE TO RELATED APPLICATIONS

This application is a 371 of International Patent Application Number PCT/CN2019/108916, filed on Sep. 29, 2019, which claims the benefit and priority of Chinese Patent Application Number 201910574765.9, filed on Jun. 28, 2019 with China National Intellectual Property Administration, the disclosures of which are incorporated herein by reference in their entireties.

### TECHNICAL FIELD

The present application relates to the technical field of data transmission, in particular to a data transmission method and a ping-pong DMA architecture.

### BACKGROUND

Data transmission between a HOST and an accelerator board card FPGA is performed in a form of a DMA architecture. By DMA (Direct Memory Access), transmission data is transmitted from one address space to another address space.

In the DMA architecture in the prior art, a group of DMA descriptor controller corresponds to a high-speed serial computer expansion bus standard interface PCIE, the HOST configures the DMA descriptor controller in a register reading-writing manner, a data transmission module reads and writes in data transmission information from a HOST side via the high-speed serial computer expansion bus standard interface PCIE to perform an operation of data transmission.

When a reading-writing operation of data blocks is performed in several times, if the DMA descriptor controller is in a busy state, the HOST has to wait until the DMA descriptor controller is idle, and then, the HOST may perform the operation of configuring the DMA descriptor controller, thereby causing low performing efficiency.

### SUMMARY

For this purpose, the present application provides a data transmission method and a ping-pong DMA architecture, by which operations of data corresponding to different states are performed according to different states of a register, and thus, the purpose of increasing the data transmission efficiency is achieved.

For achieving the above-mentioned purpose, solutions which have been proposed at present are described as follows.

In a first aspect of the present application, disclosed is a data transmission method, applied to a ping-pong DMA architecture, wherein the ping-pong DMA architecture includes a first DMA module and a second DMA module. The method includes:

acquiring the current state of an initialized register; and

determining a state type corresponding to the current state of the register, and performing an operation corresponding to the state type based on the state type determined by the register, wherein the state includes an initialization state, a state that the first DMA module is used, and a state that the second DMA module is used, the state that the first DMA module is used means a state when a previous batch of data is transmitted by the first DMA module, and the state that the second DMA module is used means a state when the previous batch of data is transmitted by the second DMA module.

Preferably, if it is determined that the state type corresponding to the current state of the register is the initialization state, performing the operation corresponding to the state type based on the state type determined by the register includes:

if the state type corresponding to the current state of the register is the initialization state, enabling the first DMA module to configure DMA data; and

transmitting the configured DMA data, and setting the state type corresponding to the current state of the register as the state that the first DMA module is used, wherein the DMA data includes a DMA reading-writing flag, a DMA data transmission length, and DMA source and destination addresses.

Preferably, if it is determined that the state type corresponding to the current state of the register is the state that the first DMA module is used, performing the operation corresponding to the state type based on the state type determined by the register includes:

if the state type corresponding to the current state of the register is the state that the first DMA module is used, enabling the second DMA module to configure the DMA data; and

transmitting the configured DMA data, and setting the state type corresponding to the current state of the register as the state that the second DMA module is used.

Preferably, if it is determined that the state type corresponding to the current state of the register is the state that the second DMA module is used, performing the operation corresponding to the state type based on the state type determined by the register includes:

if the state type corresponding to the current state of the register is the state that the second DMA module is used, enabling the first DMA module to configure the DMA data; and

transmitting the configured DMA data, and setting the state type corresponding to the current state of the register as the state that the first DMA module is used.

In a second aspect of the present application, disclosed is a ping-pong DMA architecture, including:

a first DMA module, a second DMA module, registers, a processor, and a data transmission module;

the processor being used for acquiring the current state of an initialized register, determining a state type corresponding to the current state of the register, and performing an operation corresponding to the state type based on the state type determined by the register, wherein the state type includes an initialization state, a state that the first DMA module is used, and a state that the second DMA module is used, the state that the first DMA module is used means a state when a previous batch of data is transmitted by the first DMA module, and the state that the second DMA module is used means a state when the previous batch of data is transmitted by the second DMA module.

Preferably, the ping-pong DMA architecture includes:

the first DMA module used for configuring DMA data when the processor determines that the state type corresponding to the current state of the register is the initialization state;

the data transmission module used for transmitting the configured DMA data; and

the processor used for setting the state type corresponding to the current state of the register as the state that the first DMA module is used, wherein the DMA data includes a DMA reading-writing flag, a DMA data transmission length, and DMA source and destination addresses.

Preferably, the ping-pong DMA architecture includes:

the second DMA module used for configuring the DMA data when the processor determines that the state type corresponding to the current state of the register is the state that the first DMA module is used;

the data transmission module used for transmitting the configured DMA data; and

the processor used for setting the state type corresponding to the current state of the register as the state that the second DMA module is used.

Preferably, the ping-pong DMA architecture includes:

the first DMA module used for configuring the DMA data when the processor determines that the state type corresponding to the current state of the register is the state that the second DMA module is used;

the data transmission module used for transmitting the configured DMA data; and

the processor used for setting the state type corresponding to the current state of the register as the state that the first DMA module is used.

Preferably, each of the first DMA module and the second DMA module includes:

a reading descriptor cache memory and a writing descriptor cache memory.

Preferably, the data transmission module includes:

a DMA writing control unit and a DMA reading control unit.

Known from the above-mentioned technical solutions, the current state of an initialized register is acquired, a state type corresponding to the current state of the register is determined, and an operation corresponding to the state type is performed based on the state type determined by the register, wherein the state type includes an initialization state, a state that the first DMA module is used, and a state that the second DMA module is used, the state that the first DMA module is used means a state when a previous batch of data is transmitted by the first DMA module, and the state that the second DMA module is used means a state when the previous batch of data is transmitted by the second DMA module. By using the above-mentioned method, data is configured by using the two DMA modules, when the first DMA module is busy, the second DMA module may also configure the data, and operations of data corresponding to the different state types are performed according to the different state types of the register, so that the purpose of increasing the data transmission efficiency is achieved.

The above description merely summarizes the technical solutions of the present application. In order to know about the technical means of the present application more clearly, the present application may be implemented according to the content of the description. Moreover, in order to make the above and other objectives, features and advantages of the present application more obvious and understandable, the specific implementation manners of the present application will be specially illustrated as below.

### BRIEF DESCRIPTION OF THE DRAWINGS

To describe the technical solutions in the embodiments of the present application or the prior art more clearly, the accompanying drawings required for describing the embodiments or the prior art will be briefly described below. Apparently, the accompanying drawings in the following description show only the embodiments of the present application, and a person of ordinary skill in the art may still derive other accompanying drawings from these accompanying drawings without creative efforts.

FIG. 1 is a schematic diagram showing a process of a data transmission method in accordance with an embodiment of the present application;

FIG. 2 is a schematic diagram showing a process of performing an operation corresponding to an initialization state based on a state type determined as the initialization state by a register in accordance with an embodiment of the present application;

FIG. 3 is a schematic diagram showing a process of performing an operation corresponding to a state that the first DMA module is used based on a state type determined as the state that the first DMA module is used by the register in accordance with an embodiment of the present application;

FIG. 4 is a schematic diagram showing a process of performing an operation corresponding to a state that the second DMA module is used based on a state type determined as the state that the second DMA module is used by the register in accordance with an embodiment of the present application; and

FIG. 5 is a schematic diagram showing a structure of a ping-pong DMA architecture in accordance with an embodiment of the present application.

### DETAILED DESCRIPTION

The technical solutions in the embodiments of the present application will be described clearly and completely below in conjunction with the accompanying drawings in the embodiments of the present application. Obviously, the described embodiments are a part of the embodiments of the present application, not all the embodiments. Based on the embodiments of the present application, all other embodiments obtained by those of ordinary skill in the art without creative work shall fall within the protection scope of the present application.

In the present application, the term “includes”, “including” or any other variants thereof are intended to cover non-excludable inclusion, so that a process, method, object or equipment including a series of elements not only includes those elements, but also includes other elements not listed clearly, or further includes inherent elements of the process, method, object or equipment. Under the condition that no more limitations are provided, elements defined by the word “including a . . . ” do not exclude other same elements further existing in the process, method, object or equipment including the elements.

Known from the background art, in a DMA architecture in the prior art, a group of DMA descriptor controller corresponds to a high-speed serial computer expansion bus standard interface PCIE, the HOST configures the DMA descriptor controller in a register reading-writing manner, a data transmission module reads and writes in data transmission information from a HOST side via the high-speed serial computer expansion bus standard interface PCIE to perform an operation of data transmission. When a reading-writing operation of data blocks is performed in several times, if the DMA descriptor controller is in a busy state, the HOST has to wait until the DMA descriptor controller is idle, and then, the HOST may perform the operation of configuring the DMA descriptor controller, thereby causing low performing efficiency.

Therefore, the present application discloses a data transmission method and a ping-pong DMA architecture, by which operations of data corresponding to different state types are performed according to different state types of a register, and thus, the purpose of increasing the data transmission efficiency is achieved.

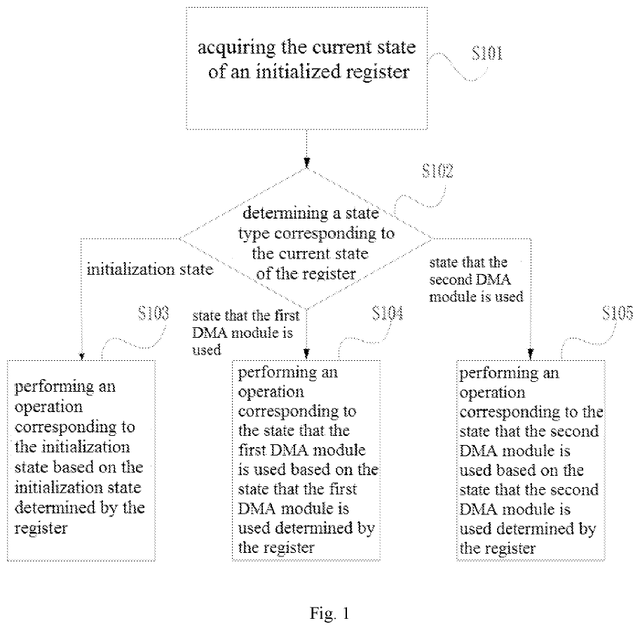

As shown in FIG. 1 which is a schematic diagram showing a process of a data transmission method in accordance with an embodiment of the present application, the process specifically includes the following steps.

Step S101: the current state of an initialized register is acquired.

In a process that the step S101 is performed, the numerical value of the initialized register is 00.

It should be noted that the register is a high-speed storage device and may be used for temporarily storing data such as instructions, data and addresses.

In an application scenario of the present application, it is determined whether a batch of data needs to be transmitted; if so, the numerical value of the register is read; and if not, waiting is further performed until a batch of data needs to be transmitted, and then, an operation of reading the numerical value of the register is performed.

Step S102: a state type corresponding to the current state of the register is determined.

In a process that the step S102 is performed, the current state of the register is determined by determining the numerical value of the register, and different numerical values in the register correspond to different states.

It should be noted that the state includes an initialization state, a state that the first DMA module is used, and a state that the second DMA module is used.

The state that the first DMA module is used means a state when a previous batch of data is transmitted by the first DMA module, and the state that the second DMA module is used means a state when the previous batch of data is transmitted by the second DMA module.

Step S103: if the state type corresponding to the current state of the register is the initialization state, an operation corresponding to the initialization state is performed based on the initialization state determined by the register.

In a process that the step S103 is performed, when the numerical value of the register is 00, the state type corresponding to the current state of the register is the initialization state.

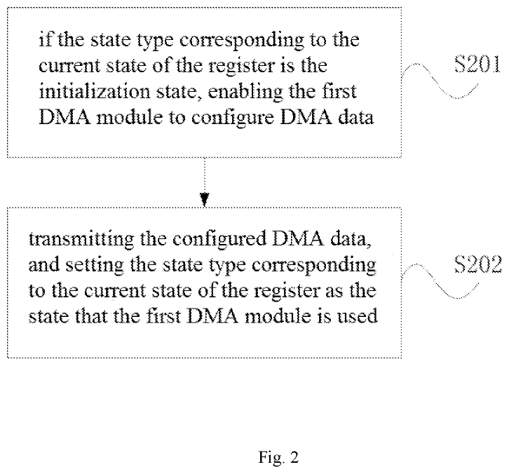

The process that if the state type corresponding to the current state of the register is the initialization state, the operation corresponding to the initialization state is performed based on the initialization state determined by the register in the above-mentioned step S103, referring to FIG. 2 which is a schematic diagram showing a process of performing the operation corresponding to the initialization state type based on the state determined as the initialization state by the register, specifically includes the following steps.

Step S201: if the state type corresponding to the current state of the register is the initialization state, the first DMA module is enabled to configure DMA data.

In a process that the step S201 is performed, information such as a DMA reading-writing flag, a DMA data transmission length, and DMA source and destination addresses in the DMA data is configured by the first DMA module.

It should be noted that the DMA module is used for controlling the DMA descriptor controller.

The DMA (Direct Memory Access) is an high-speed data transmission operation and allows an operation of directly reading and writing data in external equipment and a memory.

Step S202: the configured DMA data is transmitted, and the state type corresponding to the current state of the register is set as the state that the first DMA module is used.

In a process that the step S202 is performed, the numerical value of the register is set as 01, and the state type corresponding to the current state of the register is the state that the first DMA module is used.

It should be noted that when the numerical value of the register is 01, an operation of transmitting the previous batch of data is performed by using the first DMA module.

By the step S201 to the step S202, if the state type corresponding to the current state of the register is the initialization state, the first DMA module is enabled to configure the DMA data, the configured DMA data is transmitted, and the state type corresponding to the current state of the register is set as the state that the first DMA module is used.

Step S104: if the state type corresponding to the current state of the register is the state that the first DMA module is used, an operation corresponding to the state that the first DMA module is used is performed based on the state that the first DMA module is used determined by the register.

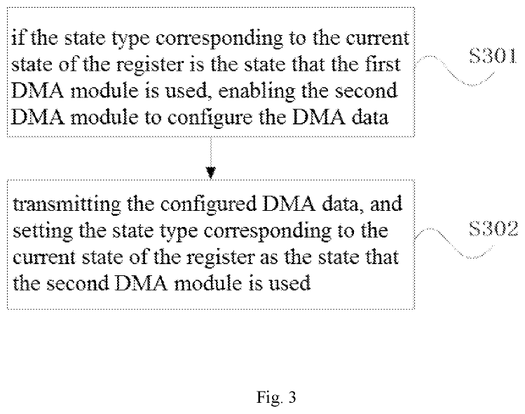

The process that if the state type corresponding to the current state of the register is the state that the first DMA module is used, the operation corresponding to the state that the first DMA module is used is performed based on the state that the first DMA module is used determined by the register in the above-mentioned step S104, referring to FIG. 3 which is a schematic diagram showing a process of performing the operation corresponding to the state that the first DMA module is used based on the state type determined as the state that the first DMA module is used by the register, specifically includes the following steps.

Step S301: if the state type corresponding to the current state of the register is the state that the first DMA module is used, the second DMA module is enabled to configure the DMA data.

In a process that the step S301 is performed, information such as a DMA reading-writing flag, a DMA data transmission length, and DMA source and destination addresses in the DMA data is configured by the second DMA module.

Step S302: the configured DMA data is transmitted, and the state type corresponding to the current state of the register is set as the state that the second DMA module is used.

In a process that the step S302 is performed, the numerical value of the register is set as 02, and the state type corresponding to the current state of the register is the state that the second DMA module is used.

It should be noted that when the numerical value of the register is 02, an operation of transmitting the previous batch of data is performed by using the second DMA module.

By the step S301 to the step S302, if the state type corresponding to the current state of the register is the state that the first DMA module is used, the second DMA module is enabled to configure the DMA data, the configured DMA data is transmitted, and the state type corresponding to the current state of the register is set as the state that the second DMA module is used

Step S105: if the state type corresponding to the current state of the register is the state that the second DMA module is used, an operation corresponding to the state that the second DMA module is used is performed based on the state that the second DMA module is used determined by the register.

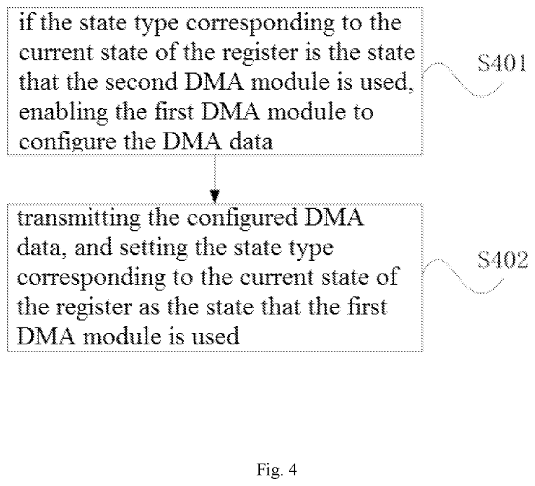

The process that if the state type corresponding to the current state of the register is the state that the second DMA module is used, the operation corresponding to the state that the second DMA module is used is performed based on the state that the second DMA module is used determined by the register in the above-mentioned step S105, referring to FIG. 4 which is a schematic diagram showing a process of performing the operation corresponding to the state that the second DMA module is used based on the state determined as the state that the second DMA module is used by the register, specifically includes the following steps.

Step S401: if the state type corresponding to the current state of the register is the state that the second DMA module is used, the first DMA module is enabled to configure the DMA data.

Step S402: the configured DMA data is transmitted, and the state type corresponding to the current state of the register is set as the state that the first DMA module is used.

In a process that the step S402 is performed, when the numerical value of the register is set as 01, the state type corresponding to the current state of the register is changed into the state that the first DMA module is used.

By the step S401 to the step S402, if the state type corresponding to the current state of the register is the state that the second DMA module is used, the first DMA module is enabled to configure the DMA data, the configured DMA data is transmitted, and the state type corresponding to the current state of the register is set as the state that the first DMA module is used.

The above-mentioned data transmission method is described by way of examples herein.

First scenario embodiment: the current state of an initialized register is acquired, when the numerical value of the register is 00, a state type corresponding to the current state of the register is an initialization state, a first DMA module is enabled to configure a DMA reading-writing flag, a DMA data transmission length, and DMA source and destination addresses in the DMA data, the configured DMA data is transmitted, and the initialization state of the register is set as a state that the first DMA module is used, that is, the numerical value of the register is set as 01.

Second scenario embodiment: the current state of an initialized register is acquired, when the numerical value of the register is 01, a state type corresponding to the current state of the register is a state that the first DMA module is used, a second DMA module is enabled to configure a DMA reading-writing flag, a DMA data transmission length, and DMA source and destination addresses in the DMA data, the configured DMA data is transmitted, and the initialization state of the register is set as a state that the second DMA module is used, that is, the numerical value of the register is set as 02.

Third scenario embodiment: the current state of an initialized register is acquired, when the numerical value of the register is 02, a state type corresponding to the current state of the register is a state that the second DMA module is used, a first DMA module is enabled to configure a DMA reading-writing flag, a DMA data transmission length, and DMA source and destination addresses in the DMA data, the configured DMA data is transmitted, and the initialization state of the register is set as a state that the first DMA module is used, that is, the numerical value of the register is set as 01.

Embodiments of the present application disclose a data transmission method by which the current state of an initialized register is acquired, a state type corresponding to the current state of the register is determined, and an operation corresponding to the state type is performed based on the state type determined by the register, wherein the state includes an initialization state, a state that the first DMA module is used, and a state that the second DMA module is used, the state that the first DMA module is used means a state when a previous batch of data is transmitted by the first DMA module, and the state that the second DMA module is used means a state when the previous batch of data is transmitted by the second DMA module. By using the above-mentioned method, data is configured by using the two DMA modules, when the first DMA module is busy, the second DMA module may also configure the data, and operations of data corresponding to the different state types are performed according to the different state types of the register, so that the purpose of increasing the data transmission efficiency is achieved.

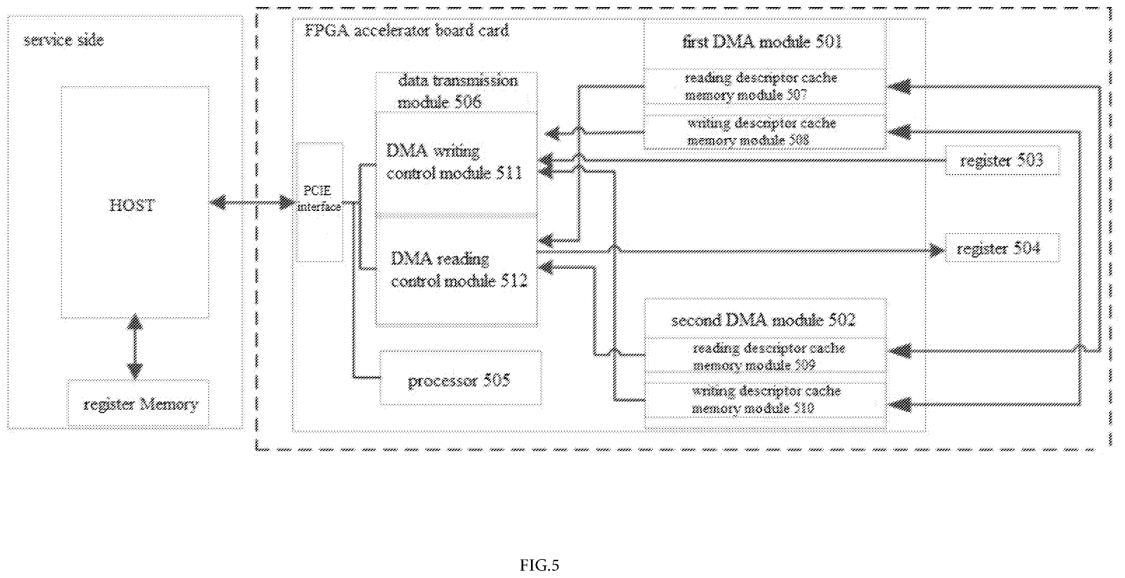

As shown in FIG. 5 which is a schematic diagram showing a structure of a ping-pong DMA architecture in accordance with an embodiment of the present application. The ping-pong DMA architecture 500 mainly includes:

a first DMA module 501, a second DMA module 502, a register 503, a register 504, a processor 505, and a data transmission module 506.

The first DMA module 501 is used for configuring DMA data when the processor determines that the state type corresponding to the current state of the register is an initialization state and configuring the DMA data when the processor determines that the state type corresponding to the current state of the register is a state that the second DMA module is used.

The second DMA module 502 is used for configuring the DMA data when the processor determines that the state type corresponding to the current state of the register is the state that the first DMA module is used.

The register 503 is used for storing data.

It should be noted that the function of the register 503 is consistent with that of the register 504.

The processor 505 is used for acquiring the current state of an initialized register, determining a state type corresponding to the current state of the register, performing an operation corresponding to the state type based on the state type determined by the register, setting the state type corresponding to the current state of the register as the state that the first DMA module is used, setting the state type corresponding to the current state of the register as the state that the second DMA module is used, and setting the state type corresponding to the current state of the register as the state that the first DMA module is used.

The data transmission module 506 is used for transmitting the configured DMA data.

Further, the first DMA module 501 includes:

a reading descriptor cache memory module 507 and a writing descriptor cache memory module 508.

The reading descriptor cache memory module 507 is used for storing a reading descriptor.

The writing descriptor cache memory module 508 is used for storing a writing descriptor.

Further, the second DMA module 502 includes:

a reading descriptor cache memory module 509 and a writing descriptor cache memory module 510.

It should be noted that the function of the reading descriptor cache memory module 509 is consistent with that of the reading descriptor cache memory module 507, and the function of the writing descriptor cache memory module 510 is consistent with that of the writing descriptor cache memory module 508.

Further, the data transmission module 506 includes:

a DMA writing control module 511 and a DMA reading control module 512.

The DMA writing control module 511 is used for initiating a DMA writing operation.

The DMA reading control module 512 is used for initiating a DMA reading operation.

It should be noted that an interface PCIE corresponds to the first DMA module and a second DMA module to form a ping-pong architecture. When the first DMA module works, the second DMA module is in a preparation state and is capable of configuring DMA data in the preparation state. When the work of the first DMA module ends, the second DMA module works, the first DMA module is in the preparation state and is capable of configuring the DMA data in the preparation state.

The ping-pong architecture means that two groups of structures including a first structure and a second structure are provided. When the first structure performs a first operation, the second structure performs a second operation. When it reaches a certain moment, actions of the first structure and the second structure are interchanged, the first structure performs the second operation, and the second structure performs the first operation, so that the operation is uninterrupted to form coherence.

The process of performing data transmission of the ping-pong DMA architecture 500 is described as follows.

Step-1, when an accelerator board card FPGA is electrified, the register 503 is in the initialization state, that is, the numerical value of the register 503 is 00.

Step-2, it is determined whether a batch of data needs to be transmitted by the first DMA module 501; if not, waiting is further performed until a batch of data needs to be transmitted by the first DMA module 501; and if so, Step-3 is performed.

Step-3, the numerical value of the register 503 is read.

Step-4, it is determined whether the numerical value of the register 503 is 00; if so, the first DMA module 501 is used to configure DMA data, the configured DMA data is transmitted, the numerical value of the register 503 is set as 01, and the Step-2 is performed; and if not, Step-5 is performed.

Step-5, it is determined whether the numerical value of the register 503 is 01; if so, the second DMA module 502 is used to configure DMA data, the configured DMA data is transmitted, the numerical value of the register 503 is set as 02, and the Step-2 is performed; and if not, Step-6 is performed.

Step-6, it is determined whether the numerical value of the register 503 is 02; if so, the first DMA module 501 is used to configure DMA data, the configured DMA data is transmitted, the numerical value of the register 503 is set as 01, and the Step-2 is performed; and if not, the Step-2 is performed.

The ping-pong DMA architecture 500 is formed based on the Step-1 to the Step-6 to perform the operation of uninterruptedly transmitting the DMA data.

It should be noted that the ping-pong DMA architecture 500 is connected with the HOST of a server side via the interface PCIE.

Embodiments of the present application disclose a ping-pong DMA architecture by which the current state of an initialized register is acquired, a state type corresponding to the current state of the register is determined, and an operation corresponding to the state is performed based on the state determined by the register. By using the above-mentioned architecture, data is configured by using two DMA modules, when a first DMA module is busy, a second DMA module may also configure the data, and operations of data corresponding to the different states are performed according to the different states of the register, so that the purpose of increasing the data transmission efficiency is achieved.

All the embodiments in the description are described in a progressive manner, the same or similar parts among all the embodiments may refer to each other, and the emphasis in each of the embodiments will focus on differences from other embodiments. Particularly, because a system or embodiments thereof are basically similar to the embodiments of the method, the description of the system or the embodiments thereof is relatively simple, and for relevant parts, reference may be made to the descriptions of the embodiments of the methods. The above-mentioned system and the embodiments thereof are merely schematic, wherein the units described as a separation component may be or not be physically separated, and a component serving as a unit for display may be or not be a physical unit, that is, they may be located on the same place or distributed on a plurality of network units. Parts or all of the modules may be selected according to an actual demand to achieve the purpose of the solution in the present embodiment. The present application may be understood and implemented by the ordinary skill in the art without creative work.

Those skilled in the art may further realize that the units and algorithm steps in all examples described in combination with the embodiments disclosed in the present application may be implemented by electronic hardware, computer software or a combination of both. In order to describe the interchangeability of the hardware and the software clearly, constitution and steps of all the examples have been described generally in the above description according to functions. Whether these functions are implemented by hardware or software depends upon specific applications and design constraints of the technical solutions. Professional technicians may adopt different methods to achieve the described functions in each specific application, which, however, should be considered as falling within the scope of the present application.

Due to the foregoing description of the disclosed embodiments, those skilled in the art may implement or use the present application. Multiple amendments to these embodiments are obvious to those skilled in the art, and general principles defined in the present application may be achieved in the other embodiments without departing from the spirit or scope of the present application. Thus, the present application will be not limited to these embodiments shown in the present application, but shall accord with the widest scope consistent with the principles and novel characteristics disclosed by the present application.

1. A data transmission method, applied to a ping-pong DMA architecture, wherein the ping-pong DMA architecture comprises a first DMA module and a second DMA module, and the method comprises:
acquiring the current state of an initialized register; and
determining a state type corresponding to the current state of the register, and performing an operation corresponding to the state type based on the state type determined by the register, wherein the state type comprises an initialization state, a state that the first DMA module is used, and a state that the second DMA module is used, the state that the first DMA module is used means a state when a previous batch of data is transmitted by the first DMA module, and the state that the second DMA module is used means a state when the previous batch of data is transmitted by the second DMA module.

2. The method of claim 1, wherein if the state type corresponding to the current state of the register is determined as the initialization state, performing the operation corresponding to the state type based on the state type determined by the register comprises:
if the state type corresponding to the current state of the register is the initialization state, enabling the first DMA module to configure DMA data; and
transmitting the configured DMA data, and setting the state type corresponding to the current state of the register as the state that the first DMA module is used, wherein the DMA data comprises a DMA reading-writing flag, a DMA data transmission length, and DMA source and destination addresses.

3. The method of claim 1, wherein if the state type corresponding to the current state of the register is determined as the state that the first DMA module is used, performing the operation corresponding to the state type based on the state type determined by the register comprises:
if the state type corresponding to the current state of the register is the state that the first DMA module is used, enabling the second DMA module to configure the DMA data; and
transmitting the configured DMA data, and setting the state type corresponding to the current state of the register as the state that the second DMA module is used.

4. The method of claim 1, wherein if the state type corresponding to the current state of the register is determined as the state that the second DMA module is used, performing the operation corresponding to the state type based on the state type determined by the register comprises:
if the state type corresponding to the current state of the register is the state that the second DMA module is used, enabling the first DMA module to configure the DMA data; and
transmitting the configured DMA data, and setting the state type corresponding to the current state of the register as the state that the first DMA module is used.

5. The method of claim 1, wherein, the state type corresponding to the current state of the register is determined according to correspondences between numerical values and different states.

6-10. (canceled)
